(19) United States
(12) Patent Application Publication
(10) Pub. No.: US 2025/0344205 A1
(43) Pub. Date: Nov. 6, 2025

(54) ENHANCING HYBRID AUTOMATIC REPEAT REQUEST (HARQ) PROCESS SELECTION FOR DELAY-CRITICAL DATA

(71) Applicant: LENOVO (SINGAPORE) PTE LIMITED, SINGAPORE (SG)

(72) Inventors: Joachim LÖHR, Wiesbaden (DE); Shwetha SREEJITH, Homburg (DE)

(21) Appl. No.: 18/653,227

(22) Filed: May 2, 2024

(51) Int. Cl. H04W 72/1268; H04L 1/1812; H04W 72/566; H04W 80/02

(52) U.S. Cl. CPC H04W 72/1268; H04L 1/1812; H04W 72/566; H04W 80/02

(57) ABSTRACT

Various aspects of the present disclosure relate to enabling a network to implement the use of delay status information when performing certain reporting (delay status reports, or DSR) and/or transmission procedures (logical channel prioritization (LCP) procedures). For example, hybrid automatic repeat request (HARQ) processes may be adapted to prioritize delay-critical data units.

### TECHNICAL FIELD

The present disclosure relates to wireless communications, and more specifically to enhancing hybrid automatic repeat request (HARQ) process selection for delay-critical data.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support extended reality (XR) communications, such as virtual reality (VR), augmented reality (AR), or other XR applications. In some cases, the wireless communications system maps data (e.g., packet data unit (PDU) sets of varying importance levels to the same quality of service (QOS) flow and radio bearers. For example, both intra-coded frames (I-frames) and predicted frames (P-frames) of a video stream may be carried by the same QoS flow/radio bearer.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to implement the use of delay status information when performing certain uplink transmission procedures (e.g., HARQ process ID selection procedure and/or logical channel prioritization (LCP) procedures) in order to maximize the transmission of delay-critical/urgent data.

Some implementations of the method and apparatuses described herein may further include a UE for wireless communication, comprising at least one memory, and at least one processor coupled with the at least one memory and configured to cause the UE to receive an uplink grant for an uplink transmission, wherein the uplink grant is a configured uplink grant of a configured grant transmission, determine a priority for each HARQ process ID of a set of HARQ process IDs available for the configured grant transmission and configured for the configured grant transmission, wherein the priority is based on: a priority of logical channels that are multiplexed or have data to be multiplexed in a medium access control (MAC) packet data unit (PDU) transmitted on the configured uplink grant, and a parameter associated with data associated with the logical channels, and select a HARQ process ID for the configured grant transmission based on the determined priorities for the set of HARQ process IDs.

In some implementations of the method and apparatuses described herein, the parameter comprises a latency value for the data associated with the logical channels.

In some implementations of the method and apparatuses described herein, the parameter comprises a remaining time that is available for transmission of the data associated with the logical channels.

In some implementations of the method and apparatuses described herein, the data associated with the logical channels comprises a radio link control (RLC) service data unit (SDU).

In some implementations of the method and apparatuses described herein, the data associated with the logical channels comprises delay-critical SDUs.

In some implementations of the method and apparatuses described herein, the data associated with the logical channels comprises delay-critical PDUs.

Some implementations of the method and apparatuses described herein may further include a processor for wireless communication, comprising at least one controller coupled with at least one memory and configured to cause the processor to receive an uplink grant for an uplink transmission, wherein the uplink grant is a configured uplink grant of a configured grant transmission, determine a priority for each HARQ process ID of a set of HARQ process IDs available for the configured grant transmission and configured for the configured grant transmission, wherein the priority is based on a priority of logical channels that are multiplexed or have data to be multiplexed in a MAC PDU transmitted on the configured uplink grant and a parameter associated with data associated with the logical channels, and select a HARQ process ID for the configured grant transmission based on the determined priorities for the set of HARQ process IDs.

In some implementations of the method and apparatuses described herein, the parameter comprises a latency value for the data associated with the logical channels.

In some implementations of the method and apparatuses described herein, the parameter comprises a remaining time that is available for transmission of the data associated with the logical channels.

In some implementations of the method and apparatuses described herein, the data associated with the logical channels comprises an RLC SDU.

In some implementations of the method and apparatuses described herein, the data associated with the logical channels comprises delay-critical SDUs.

In some implementations of the method and apparatuses described herein, the data associated with the logical channels comprises delay-critical PDUs.

Some implementations of the method and apparatuses described herein may further include a method performed by a UE, the method comprising receiving an uplink grant for an uplink transmission, wherein the uplink grant is a configured uplink grant of a configured grant transmission, determining a priority for each HARQ process ID of a set of HARQ process IDs available for the configured grant transmission and configured for the configured grant transmission, wherein the priority is based on a priority of logical channels that are multiplexed or have data to be multiplexed in a MAC PDU transmitted on the configured uplink grant and a parameter associated with data associated with the logical channels, and selecting a HARQ process ID for the configured grant transmission based on the determined priorities for the set of HARQ process IDs.

In some implementations of the method and apparatuses described herein, the parameter comprises a latency value for the data associated with the logical channels.

In some implementations of the method and apparatuses described herein, the parameter comprises a remaining time that is available for transmission of the data associated with the logical channels.

In some implementations of the method and apparatuses described herein, the data associated with the logical channels comprises an RLC SDU.

In some implementations of the method and apparatuses described herein, the data associated with the logical channels comprises delay-critical SDUs.

In some implementations of the method and apparatuses described herein, the data associated with the logical channels comprises delay-critical PDUs.

Some implementations of the method and apparatuses described herein may further include a UE for wireless communication, comprising at least one memory, and at least one processor coupled with the at least one memory and configured to cause the UE to assign, at an RLC layer, a transmission priority to RLC PDUs based on delay information associated with RLC SDUs contained by the RLC PDUs and transmit the RLC PDUs based on the assigned transmission priority.

In some implementations of the method and apparatuses described herein, the at least one processor is configured to cause the UE to assign a higher transmission priority to a RLC PDU containing a RLC SDU or RLC SDU segment that has not been previously transmitted with respect to a RLC PDU containing a previously transmitted RLC SDU or RLC segment.

### BRIEF DESCRIPTION OF THE DRAWINGS

FIG. 1 illustrates an example of a wireless communications system in accordance with aspects of the present disclosure.

FIG. 2 illustrates an example block diagram that depicts communications between a UE and a network entity in accordance with aspects of the present disclosure.

FIG. 3 illustrates an example block diagram that depicts allocating UL resources to a UE for an enhanced LCP procedure in accordance with aspects of the present disclosure.

FIG. 4 illustrates an example block diagram that depicts network control of an LCP procedure in accordance with aspects of the present disclosure.

FIG. 5 illustrates an example block diagram that depicts selection of a HARQ process in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

FIG. 11 illustrates a flowchart of a method performed by a UE in accordance with aspects of the present disclosure.

FIG. 12 illustrates a flowchart of a method performed by a UE in accordance with aspects of the present disclosure.

### DETAILED DESCRIPTION

In some wireless communication systems, a QoS flow and/or radio bearer for XR communications (e.g., XR data traffic) may carry PDU sets (or other application data units (ADUs)), such as I-frames and P-frames, having different or varying levels of importance (e.g., PDU set importance (PSI) levels). Via legacy QoS flow architectures, all data packets (PDUs) of a radio bearer experience a similar QoS experience.

In such cases, the legacy QoS may cause an inefficient handling of PDU sets and other similar data types that have varying levels of importance. For example, an XR application may attempt to transmit many PDU sets over a network, where the PDU sets have different levels of importance. However, by employing legacy QoS, the XR application may discard or drop certain important PDU sets in favor of relatively less important PDU sets, among other drawbacks.

The technology described herein provides for new or enhanced layer 2 procedures, which can include features that consider certain statuses of data units, such as delay status information, when performing certain reporting (delay status reports, or DSR) and/or transmission procedures. For example, an LCP procedure may identify data units (e.g., PDU sets of SDU sets) that satisfy a delay condition for transmission (e.g., delay-critical data units), and assign, via a MAC layer, uplink resources allocated by an uplink grant to logical channels associated with the identified data units.

As another example, hybrid automatic repeat request (HARQ) processes may be adapted to prioritize delay-critical data units. For example, a MAC layer of a UE may prioritize a HARQ process carrying delay-critical data over other HARQ processes that do not carry delay-critical data.

Thus, in various embodiments, a wireless communications system may maximize the transmission of urgent data (e.g., delay-critical data units) by enhancing legacy UL scheduling procedures (e.g., LCP or DSR procedures), HARQ process selection procedures, and other procedures that facilitate the transmission of data between UEs and the network. These enhanced procedures can improve the implementation and support of XR applications, which generate and transmit urgent data (e.g., PDU sets) when providing XR services and applications to users of various mobile devices, among other benefits.

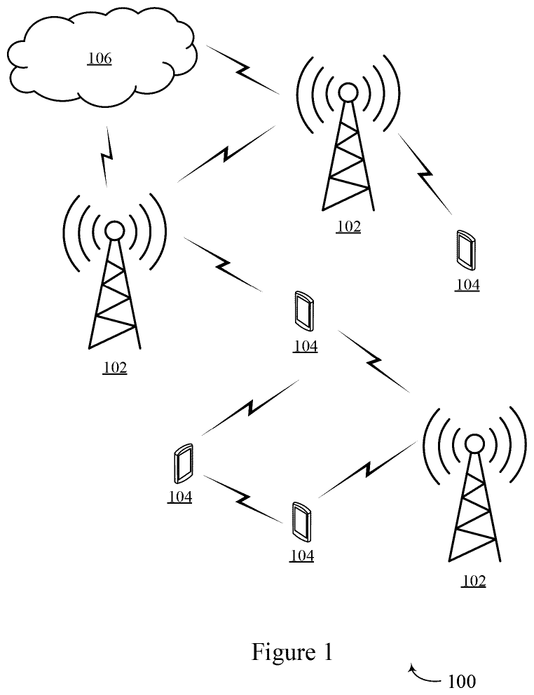

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, the UE 104 may trigger and transmit a DSR to inform the NE 102 (e.g., a gNB scheduler) of urgent and/or delay-critical data pending in a buffer of the UE. Delay-critical data may include data for which an associated remaining delay is below a preconfigured threshold.

In some cases, delay-critical data, based on delay status reporting, may include delay-critical RLC SDUs and delay-critical RLC SDU segments that have not yet been included in an RLC data PDU, RLC data PDUs pending for initial transmission, which contain a delay-critical RLC SDU or a delay-critical RLC SDU segment, RLC data PDUs that are pending for retransmission (RLC AM), and so on.

Also, for MAC delay status reporting, delay-critical data may include packet data convergence protocol (PDCP) SDUs for which no PDCP Data PDUs have been constructed, PDCP data PDUs that contain the delay-critical PDCP SDUs and have not been submitted to lower layers, PDCP Control PDUs, PDCP SDUs/PDUs to be retransmitted (for AM data resource blocks (DRBs)), and so on.

In some cases, a buffer status conveyed within a DSR includes only data for which the remaining delay is below the threshold. However, the full buffer status may not be known to the scheduler, and other higher priority data may be pending in the UE buffer having a remaining delay that is not larger than the threshold. Thus, an uplink (UL) grant issued by the scheduler in response to the reception of a DSR MAC CE may not allow transmission of urgent data or delay-critical data, due to the other higher priority data pending in the UE buffer.

For example, current LCP procedures only consider the priority of the logical channels (LCHs) and not the delay status of the packets/data units of a LCH, causing a UE to transmit higher priority and non-urgent/delay-tolerant data instead of urgent/delay-critical (yet lower priority) data for an UL grant tailored in accordance with a DSR report.

As another example, current HARQ process ID selection for configured grants only considers the priority of the LCHs, which can lead to a situation that a MAC PDU containing delay-critical data (e.g., data whose associated remaining delay is below a configured threshold) is being deprioritized during HARQ process ID selection and hence delayed. Furthermore, an RLC layer/PDCP layer may not consider the remaining delay status of a PDU when submitting PDUs to lower layer (e.g., PDUs are submitted in order to the lower layers). The RLC currently prioritizes RLC retransmissions over an RLC initial transmission, even in situations where the transmission of a delay-critical RLC PDU containing not previously transmitted RLC SDUs or RLC SDU segments is delayed.

Thus, as described herein, a UE may be configured with enhanced transmission and/or reporting procedures, such as LCP, DSR, and/or HARQ procedures, which enhance, optimize and/or maximize the transmission of delay-critical and/or urgent data within the buffer of the UE, among other benefits.

In some embodiments, a UE (e.g., the UE 104) performs an enhanced logical channel prioritization, which prioritizes the transmission of PDUs (e.g., PDUs available for transmission) with an associated remaining time being below a configured threshold. For example, the UE may enhance a current specified LCP procedure, which focuses on the transmission of high priority data (e.g., LCH priority is a main factor that determines the data or the order in which data is being multiplexed in a transport block, or TB). The current LCP procedure is a two-step/round procedure, where a UE (1) allocates uplink resources to selected/eligible LCHs (e.g., LCHs eligible for an UL grant are selected based on configured LCH mapping restrictions) in order to satisfy the PBR requirements of an LCH, and (2) allocates resources following a strict decreasing priority order (regardless of PBR requirements).

To enhance the LCP procedure, the UE performs a three-step/round LCP procedure. The three-step/round procedure introduces a new first step, where the UE allocates resources to LCHs having delay-critical SDUs/PDUs pending in the buffer of the UE for (re) transmission. The second and third steps follow the current procedure (e.g., PBR based UL resource allocation and strict priority-based resource allocation regardless of the value of Bⱼ).

For example, during the first step, the UE (e.g., via the MAC) determines a subset of LCHs carrying delay-critical SDUs/PDUs, among a set of LCHs selected according to LCH mapping restrictions. In some cases, the term “delay-critical SDUs/PDUs/PDU sets” may be understood as SDUs/PDUs/PDU sets for which the remaining time until the expiry of an associated PDCP discard timer becomes less than a configured threshold. The threshold for determining a delay-critical SDU/PDU/PDU set for the purpose of an enhanced LCP procedure may be different (e.g., a different configured threshold parameter) compared to the threshold used for determining delay-critical SDUs/PDUs used for the purpose of delay status reporting (e.g., remaining Time Threshold).

In some cases, the UE may consider or determine an LCH as delay-critical and eligible for the first step of the enhanced LCP procedure when at least one PDU/SDU of the LCH is associated with a remaining time until a discardTimer expiry is less than a configured threshold. In some cases, a signaling radio bearer (SRB) may be considered per default as a delay-critical LCH and may be selected for the first step during the enhanced LCP procedure.

In some cases, the UE/MAC allocates uplink resources to selected delay-critical LCHs in a decreasing priority order. The MAC entity may allocate the uplink resources to a delay-critical LCH until either all the delay-critical data (e.g., PDUs/SDUs for which remaining time is below a configured threshold) have been multiplexed in the UL grant or the UL grant is exhausted. The following is an example enhanced LCP procedure, as described herein, which allocates resources to logical channels as follows:

First, any delay-critical logical channels among selected logical channels are allocated resources in a decreasing priority order (regardless of the value of Bⱼ, or tokens within a bucket for a LCJ j) until the delay-critical data for that logical channel is exhausted.

Second, logical channels selected for a UL grant with Bj>0 are allocated resources in a decreasing priority order. If the PBR of a logical channel is set to infinity, the MAC entity allocates resources for all the data that is available for transmission on the logical channel before meeting the PBR of the lower priority logical channel(s).

Next, decrement Bj by the total size of MAC SDUs served to logical channel j above.

Third, if any resources remain, all the selected logical channels are served in a strict decreasing priority order (regardless of the value of Bj) until either the data for that logical channel or the UL grant is exhausted, whichever comes first. Logical channels configured with equal priority should be served equally.

With respect to the example enhanced LCP procedure, the uplink resources are allocated in the first step regardless of the value of Bj. However, in some cases, in order to address a fairness aspect, the UE may only allocate UL resources to the delay-critical LCH up to the configured PBR (e.g., considering Bⱼ of the corresponding LCH). Further, the enhanced LCP procedure may operate with the steps in different orders (e.g., step 2 before step 1) and/or perform partial steps in the presented order, depending on various implementations and/or configured thresholds. For example, the UE may include multiple thresholds that signify whether data is to be considered delay-critical, and only apply one of the thresholds when determining the LCHs to allocate UL resources before moving to the second step.

For example, a LCH may be categorized as a delay-critical LCH if there is at least one PDU/SDU of the LCH for which the remaining time until discardTimer expiry is less than a configured threshold. In another example, a LCH may be categorized as a delay-critical LCH if there is at least one PDU/SDU of the LCH for which the remaining time until discardTimer expiry is less than a configured threshold and the PDU/SDU is of high importance (e.g., an associated PSI value is set to a high importance value). In some cases, the importance level of a PDU/SDU should be above a preconfigured threshold in order to be eligible to be qualified as a delay-critical SDU/PDU and consequently categorize the LCH as a delay-critical LCH when allocating resources to LCHs.

As another example, the UE/MAC entity may utilize a different relative priority order for the enhanced LCP procedure. Currently, the UE/MAC entity prioritizes the transmission of MAC CEs over the transmission of data radio bearers. The UE, following an enhanced LCP procedure, multiplexes delay-critical data (e.g., PDUs/SDUs of a delay-critical LCH) into a TB/MAC PDU before multiplexing MAC CEs. In some cases, the UE may still prioritize certain delay critical MAC CEs (e.g., a DSR MAC CE) over delay-critical LCHs.

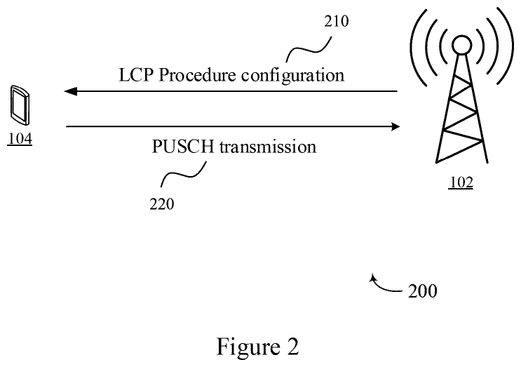

In some embodiments, the NE 102 may configure whether a LCH can be categorized as a delay-critical LCH during enhanced LCP procedures. FIG. 2 illustrates an example block diagram that depicts communications 200 between a UE and a network entity in accordance with aspects of the present disclosure.

The network, via the NE 102, configures the UE 104 (e.g., the MAC layer of the UE 104) to prioritize the data of a LCH during LCP for cases when SDUs/PDUs of that LCH have an associated remaining time less than a configured threshold (e.g., a time until a PDCP discard timer will expire is less than a configured threshold). The NE 102 may transmit an LCP configuration 210, which is received by the UE 104.

For example, a new field is configured in an information element (IE), such as in LogicalChannelconfig IE, which indicates whether the UE 104 may or should prioritize delay-critical PDUs/SDUs of a logical channel during the LCP procedure. The field, which is referred to as “Prioritize-DelayCriticalData,” is Boolean, and if set to true, indicates that the UE 104 or MAC entity of the UE 104 can categorize the LCH as a delay-critical LCH and prioritize PDU/SDUs of the LCH during the LCP procedure. For example, the UE 104 may select the LCH for the first step of an enhanced LCP procedure, as described herein, when PDUs/SDUs of the LCH have a time remaining or delay that is below a configured threshold. The UE 104 may perform a PUSCH transmission 220 based on the enhanced LCP procedure.

The following is an example implementation:

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, kBps128, |

kBps256, kBps512,

kBps1024, kBps2048, kBps4096, kBps8192, kBps16384, kBps32768, kBps65536,

infinity},

| | |
|---|---|
| bucketSizeDuration | ENUMERATED {ms5, ms10, ms20, ms50, ms100, ms150, ms300, |

ms500, ms1000,

| | |
|---|---|
| | spare 7, spare6, spare5, spare4, spare3, spare2, spare1}, |
| allowedServingCells | SEQUENCE (SIZE (1..maxNrofServingCells−1)) OF ServCellIndex |

OPTIONAL, -- Cond PDCP-

CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, ms0p125, ms0p25, |

ms0p5, ms0p01-v1700, spare1}

OPTIONAL, -- Need R

| | |
|---|---|
| configuredGrantType1Allowed | ENUMERATED {true} |

OPTIONAL, -- Need R

| | | |
|---|---|---|
| logicalChannelGroup | INTEGER (0..maxLCG-ID) | OPTIONAL, -- |

Need R

| | | |
|---|---|---|
| schedulingRequestID | SchedulingRequestId | OPTIONAL, -- |

```
Need R
    logicalChannelSR-Mask BOOLEAN,
    logicalChannelSR-DelayTimerApplied BOOLEAN,
    Prioritize-Delay CriticalData BOOLEAN,
    ...,
```

| | |
|---|---|
| bitRateQueryProhibitTimer | ENUMERATED {s0, sodot4, s0dot8, sldot6, s3, s6, s12, s30} |

OPTIONAL, -- Need R
[[

| | |
|---|---|
| allowedCG-List-r16 | SEQUENCE (SIZE (0..maxNrofConfiguredGrantConfigMAC-1-r16)) |

OF ConfiguredGrantConfigIndexMAC-r16

OPTIONAL, -- Need S

| | |
|---|---|
| allowedPHY-PriorityIndex-r16 | ENUMERATED {p0, p1} |

```
OPTIONAL -- Need S
    ]],
    [[
```

| | |
|---|---|
| logicalChannelGroupIAB-Ext-r17 | INTEGER (0..maxLCG-ID-IAB-r17) |

OPTIONAL, -- Need R

| | |
|---|---|
| allowedHARQ-mode-r17 | ENUMERATED {harqModeA, harqModeB} |

OPTIONAL -- Need R
]]

| | |
|---|---|
| } | OPTIONAL, -- Cond UL |

```
  ...,
  [[
```

| | | |
|---|---|---|
| channelAccessPriority-r16 | INTEGER (1..4) | OPTIONAL, -- Need |

R

| | | |
|---|---|---|
| bitRateMultiplier-r16 | ENUMERATED {x40, x70, x100, x200} | OPTIONAL |

-- Need R
]]
}

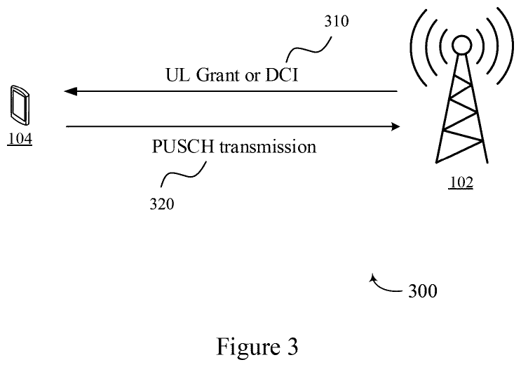

In some embodiments, the network may indicate, within an UL grant or DCI, whether an enhanced LCP procedure is to be applied for a corresponding PUSCH transmission. FIG. 3 illustrates an example block diagram 300 that depicts allocating UL resource to a UE for an enhanced LCP procedure in accordance with aspects of the present disclosure.

The NE 102 transmits, within a field of a UL Grant or UL DCI 310 (e.g., DCI format 0_1), an indication of the LCP procedure to apply for a corresponding PUSCH transmission 320. For example, the field may indicate to the UE 104 to apply an enhanced LCP procedure for the corresponding PUSCH transmission described herein and to prioritize delay-critical data during the enhanced LCP procedure.

For example, the UE 104 may introduce and/or utilize a new field or DCI format that indicates usage of the enhanced LCP procedure. As another example, an existing field within a DCI set to a specific value or a combination of existing fields set to specified predefined values/codepoints can indicate that the UE 104 is to apply the enhanced LCP procedure for a corresponding PUSCH transmission.

In some cases, the UE 104 or associated MAC entity uses an enhanced LCP procedure for initial transmission on a predefined set of HARQ processes. For example, the NE 102 configures (e.g., via radio resource control (RRC) configuration) the UE 104 to apply an enhanced LCP procedure, prioritizing the transmission of delay-critical PDUs/SDUs, to certain HARQ processes. The NE 102 may configure the UE 104 via the UL DCI 310, which can be addressed to a radio network temporary identifier (RNTI) that is different than a cell RNTI (C-RNTI) used to indicate that an enhanced LCP procedure is to be used for a corresponding PUSCH transmission. The NE 102 may allocate the new RNTI (e.g., drift RNTI, or D-RNTI) to the UE 104 via the RRC configuration.

In some embodiments, the NE 102 utilizes a configured grant configuration to indicate to the UE 104 whether to use the enhanced LCP procedure for an initial transmission on a configured grant (e.g., to maximize the transmission of delay-critical data). For example, a new field within the IE ConfiguredGrantConfig indicates whether an enhanced LCP procedure should be executed for PUSCH transmissions on the configured grants.

As another example, the NE 102 configures the UE 104 to apply (or not apply) the enhanced LCP procedure for a HARQ process used by the uplink configured grants (e.g., configuration is per HARQ process). The UE 104 may use the enhanced LCP procedure for an uplink configured grant, prioritizing delay-critical PDUs/SDUs, when an LCH, mapped to the configured grant configuration (e.g., included in allowed (′G-List that sets the allowed configured grants for transmission) is allowed to be considered/categorized as a delay-critical LCH.

In some embodiments, the UE 104 or associated MAC entity prioritizes the transmission of RLC PDUs containing delay-critical RLC SDUs or RLC SDU segments over transmission of RLC PDUs containing other (non delay-critical) RLC SDUs or RLC SDU segments. For example, an RLC entity (e.g., transmitting side) prioritizes RLC PDUs containing delay-critical RLC SDUs or RLC SDU segments over RLC retransmissions (e.g., RLC PDUs containing (not delay-critical) previously transmitted RLC SDUs or RLC SDU segments).

For example, if the RLC PDU for initial transmission and the RLC PDU for retransmission contain both delay-critical RLC SDUs or RLC segments, UE shall prioritized the RLC retransmission over the initial transmission. Thus, the UE 104, supporting an XR application and associated services, may consider the remaining time of an RLC SDU/SDU segment when determining whether to prioritize a RLC retransmission over an initial RLC PDU or when prioritizing delay-critical RLC PDUs in general regardless of whether there are initial RLC PDUs or RLC retransmissions, among other benefits. A new prioritization mechanism for RLC is introduced to make sure delay-critical packets (e.g., RLC SDUs or RLC SDU segments) are prioritized over non-delay-critical packets.

As another example, the NE 102 configures the UE 104 to identify when a RLC entity (e.g., transmitting entity) prioritizes delay-critical packets (e.g., RLC SDUs or RLC SDU segments) over non delay-critical packets. The NE 102 may configure the UE 104 within an RLC-Config IE or an RLC-BearerConfig IE as to whether the UE 104 or RLC entity is to prioritize delay-critical RLC PDUs over non delay-critical RLC PDUs.

In some embodiments, the RLC entity may deprioritize the transmission of an RLC PDU containing a RLC SDU or RLC SDU segment associated with a PDCP discard timer that is already expired. The RLC entity prioritizes the transmission of RLC PDUs containing RLC SDUs or RLC SDU segments for which the PDCP discard timer has not expired over RLC PDUs containing RLC SDUs or RLC SDU segments for which the PDCP discard timer has already expired.

In some embodiments, the PDCP layer may prioritize the transmission of PDCP SDUs for which the remaining time is below a configured threshold over PDCP SDUs for which the remaining time is above a configured threshold. For example, the PDCP layer (e.g., the transmitting side) may submit PDCP PDUs for which the corresponding SDU is delay-critical (e.g., a time until PDCP discard timer expiry is below a configured threshold) before other PDCP SDU/PDUs which are not delay-critical, even when submission of the PDCP PDUs to the RLC layer is not in ascending order of associated COUNT values. In order to meet the delay requirements of a PDU/PDU set, the PDCP layer may submit delay-critical PDUs before non-delay critical PDUs to the RLC layer. For example, the PDCP entity (e.g., the transmitting side) submits a delay-critical PDCP PDU to lower layers as the first PDCP PDU for transmission via the transmitting PDCP entity (e.g., as specified in clause 5.2.1 of TS38.323 for Uu interface).

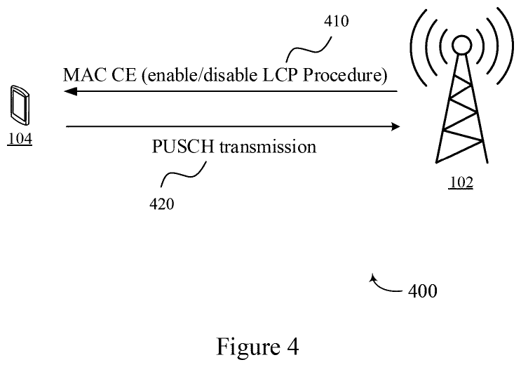

In some embodiments, the NE 102 may enable/disable the UE 104 to perform the enhanced LCP procedure for UL transmissions via new control signaling. FIG. 4 illustrates an example block diagram 400 that depicts network control of an LCP procedure mode in accordance with aspects of the present disclosure.

For example, the NE 102 may transmit a new MAC CE 410, which enables/disables the usage of the enhanced LCP procedure. When the MAC CE 410 causes the UE 104 to apply delay-aware logical channel prioritization, the UE 104 prioritizes delay-critical PDUs/SDUs during an LCP procedure, such as during a corresponding PUSCH transmission 420. However, when the MAC CE 410 causes the UE 104 to disable or not apply a prioritization of delay-critical data during the LCP procedure, the UE 104 uses a legacy LCP procedure. In some cases, the NE 102 may configure the enabling or disabling of the use of the enhanced LCP procedure at the UE 104 level, the MAC layer level, or the DRB level.

In some embodiments, the UE 104 or associated MAC entity determines the priority of an LCH when the transmission of delay-critical data is prioritized before the enhanced LCP procedure is performed. For example, the UE/MAC uses the legacy LCP procedure, but adapts the priority of an LCH based at least on a remaining time of PDUs/SDUs of the LCH. The priority of an LCH may be determined based on the configured LCH priority and the remaining time of PDUs/SDUs of the LCHs.

In some cases, the priority of an LCH is determined to be higher when PDUs/SDUs of that LCH have a remaining time less than a configured threshold (e.g., the PDUs/SDUs are delay-critical PDUs/SDUs, as described herein) in order to prioritize the delay-critical data during the LCP procedure. For example, a priority of an LCH having delay-critical data may be the highest priority during the LCP procedure.

If the LCH does not contain delay-critical data available for transmission, the UE/MAC uses the configured LCH priority during the LCP procedure. For example, the MAC entity determines the priority of an LCH by considering the remaining delay for the data of the LCH once before the LCP procedure is executed. The priority of the LCH does not change/adapt during the LCP procedure, and the legacy LCP procedure is performed.

In some embodiments, the UE 104 or associated MAC entity determines the priority of an LCH before the first step of the LCP procedure and before the second step of the LCP procedure. The UE/MAC may use different priorities for an LCH during the LCP procedure. For example, a first LCH priority is used for a first step of resource allocation (e.g., satisfying PBR requirements) and a second LCH priority for the second step (e.g., remaining uplink resources are assigned in a strict decreasing priority order) of the LCP procedure. Thus, the UE/MAC uses the legacy LCP procedure, but adapts the priority of an LCH before the different steps of the LCP procedure based at least based on a remaining time of PDUs/SDUs of the LCH.

In doing so, the UE 104 may determine the priority of an LCH at the second step, such as after delay-critical data has already been multiplexed into the TB/MAC PDU during the first round of the LCP procedure (e.g., during the first step where the priority of an LCH carrying delay-critical data is increased/set to a high priority value). If there is no delay-critical data available for transmission for that LCH after the first step of the LCP procedure, the UE/MAC entity uses the configured LCH priority for the second step of the LCP procedure. Thus, any non-delay critical PDUs/SDUs may not be unnecessarily prioritized, among other benefits.

In some embodiments, the UE 104 or associated MAC entity prioritizes delay-critical data during the enhanced LCP procedure when the remaining delay associated with the delay-critical data is below a preconfigured threshold and the remaining delay associated with higher priority data (e.g., data with a higher LCH priority compared to the delay-critical data) is greater than a different preconfigured threshold.

In some cases, the UE 104 performs the enhanced LCP prioritization (e.g., prioritizing a lower priority but more delay-critical data over a higher priority, but less delay-critical data) in response to an UL grant when the UL grant has been received at least ‘n1’ time units (e.g., slots) after the time the UE 104 has transmitted a DSR.

In some embodiments, the UE 104 may utilize a different LCH mapping restriction when data of the LCH is delay-critical. When PDUs/SDUs of the LCH available for transmission have a remaining time (e.g., a time until the expiry of a PDCP discard timer) that is less than a configured threshold, the UE 104 applies a different LCH mapping restriction for that LCH. For example, when the UE 104 is operating in a carrier aggregation mode, the data of the LCH can be transmitted on all activated serving cells/carriers (e.g., an allowedServingCells configuration is ignored), and the UE 104 is allowed to use any serving cells.

In some cases, the UE 104 may not apply any LCH mapping restriction configured by the NE 102 for an LCH when there is delay-critical data for that LCH available for transmission. In some cases, the NE 102 may configure the UE 104 to apply a second LCH mapping restriction for an LCH when SDUs/PDUs of that LCH have a remaining time that is less than a configured threshold. For example, the additional LCH mapping restriction is configured for a LCH (e.g., logicalchannelConfig IE via a RRC reconfiguration procedure).

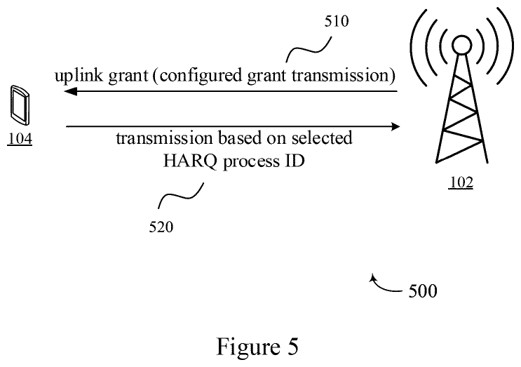

In some embodiments, the priority of a HARQ process is determined by considering the remaining delay of the data that is multiplexed or than can be multiplexed in a MAC PDU, according to the mapping restrictions. FIG. 5 illustrates an example block diagram 500 that depicts selection of a HARQ process in accordance with aspects of the present disclosure.

Currently, the priority of a UL HARQ process, used for HARQ process ID selection, is determined by the highest priority among the priorities of the LCH that are multiplexed or can be multiplexed in the corresponding MAC PDU. The UE 104 or associated MAC entity may have been allocated with an uplink grant 510 (e.g., a configured uplink grant) and perform a transmission based on a selected HARQ process ID 520. For example, the UE/MAC prioritizes a HARQ process ID with delay-critical data over other HARQ process IDs/HARQ processes not carrying delay-critical data, such as by prioritizing delay-critical data in an initial transmission before a retransmission for HARQ process ID selection.

As another example, the UE/MAC prioritizes a HARQ process when a smallest remaining delay of the data that is multiplexed or can be multiplexed in the corresponding MAC PDU is below a preconfigured threshold, in order to avoid or prevent a MAC PDU containing delay-critical data being deprioritized during HARQ process ID selection and delayed, among other benefits.

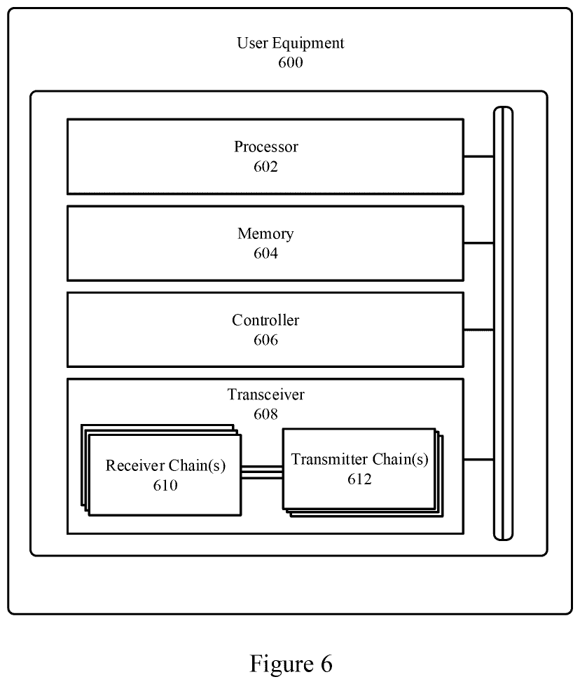

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving a configuration from a network entity, establishing multiple logical channels for transmission of data during an LCP procedure based on the configuration, receiving DCI allocating uplink resources for an initial transmission via an uplink grant, selecting a set of logical channels, from the multiple logical channels, having data eligible for transmission using the allocated uplink resources, selecting a subset of logical channels, from the set of logical channels, associated with data units in a buffer of the UE that satisfy a delay condition for transmission, and assigning, via a MAC layer of the UE, the uplink resources allocated by the uplink grant to the selected subset of logical channels.

As another example, the processor 602 may support wireless communication at the UE 600 in accordance with examples as disclosed herein. The UE 600 may be configured to support a means for receiving an uplink grant for an uplink transmission, wherein the uplink grant is a configured uplink grant of a configured grant transmission, determining a priority for each HARQ process ID of a set of HARQ process IDs available for the configured grant transmission and configured for the configured grant transmission, wherein the priority is based on: a priority of logical channels that are multiplexed or have data to be multiplexed in a MAC PDU transmitted on the configured uplink grant, and a parameter associated with data associated with the logical channels, and selecting a HARQ process ID for the configured grant transmission based on the determined priorities for the set of HARQ process IDs.

As another example, the processor 602 may support wireless communication at the UE 600 in accordance with examples as disclosed herein. The UE 600 may be configured to support a means for assigning, at an RLC layer, a transmission priority to RLC PDUs based on delay information associated with RLC SDUs contained by the RLC PDUs and transmitting the RLC PDUs based on the assigned transmission priority.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

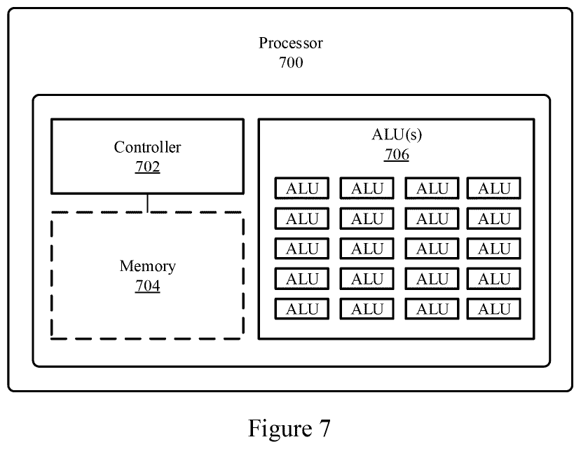

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may be configured to support a means for receiving a configuration from a network entity, establishing multiple logical channels for transmission of data during an LCP procedure based on the configuration, receiving DCI allocating uplink resources for an initial transmission via an uplink grant, selecting a set of logical channels, from the multiple logical channels, having data eligible for transmission using the allocated uplink resources, selecting a subset of logical channels, from the set of logical channels, associated with data units in a buffer of the UE that satisfy a delay condition for transmission, and assigning, via a MAC layer of the UE, the uplink resources allocated by the uplink grant to the selected subset of logical channels.

As another example, the processor 700 may be configured to support a means for receiving an uplink grant for an uplink transmission, wherein the uplink grant is a configured uplink grant of a configured grant transmission, determining a priority for each HARQ process ID of a set of HARQ process IDs available for the configured grant transmission and configured for the configured grant transmission, wherein the priority is based on: a priority of logical channels that are multiplexed or have data to be multiplexed in a MAC PDU transmitted on the configured uplink grant, and a parameter associated with data associated with the logical channels, and selecting a HARQ process ID for the configured grant transmission based on the determined priorities for the set of HARQ process IDs.

As another example, the processor 700 may be configured to support a means for assigning, at an RLC layer, a transmission priority to RLC PDUs based on delay information associated with RLC SDUs contained by the RLC PDUs and transmitting the RLC PDUs based on the assigned transmission priority.

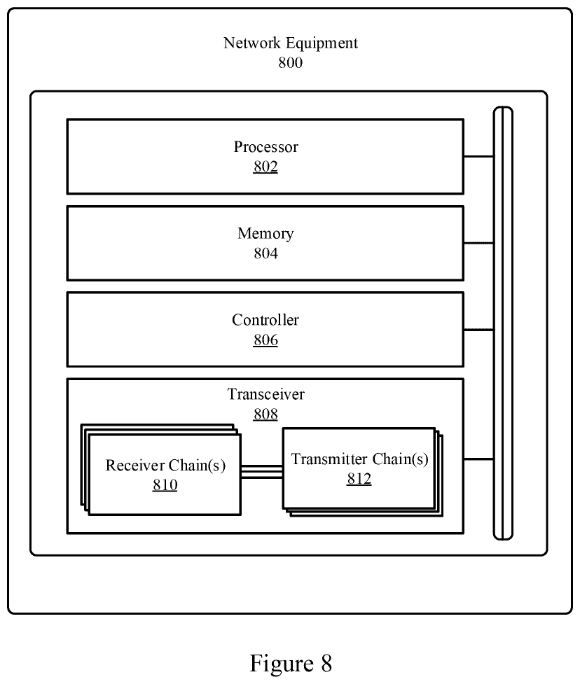

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for transmitting to a UE a configuration that identifies an LCP procedure to apply to multiple logical channels associated with data units within a buffer of the UE, wherein the LCP procedure prioritizes delay-critical PDUs or delay-critical SDUs during LCP, and receiving, from the UE, a PUSCH transmission from the UE based on the identified LCP procedure.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

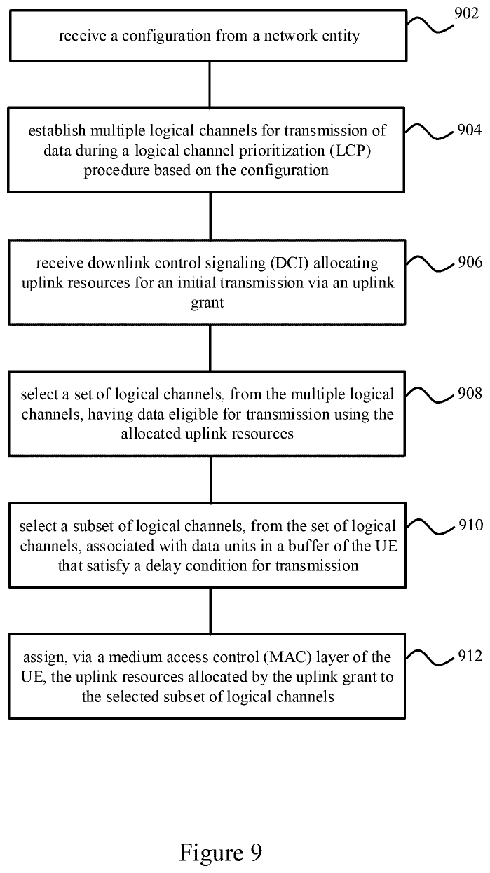

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a configuration from a network entity. The operations of 902 may be performed in accordance with examples as described herein. In some implementations, aspects of the operations of 902 may be performed by a UE as described with reference to FIG. 6.

At 904, the method may include establishing multiple logical channels for transmission of data during an LCP procedure based on the configuration. The operations of 904 may be performed in accordance with examples as described herein. In some implementations, aspects of the operations of 904 may be performed by a UE as described with reference to FIG. 6.

At 906, the method may include receiving DCI allocating uplink resources for an initial transmission via an uplink grant. The operations of 906 may be performed in accordance with examples as described herein. In some implementations, aspects of the operations of 906 may be performed by a UE as described with reference to FIG. 6.

At 908, the method may include selecting a set of logical channels, from the multiple logical channels, having data eligible for transmission using the allocated uplink resources. The operations of 908 may be performed in accordance with examples as described herein. In some implementations, aspects of the operations of 908 may be performed by a UE as described with reference to FIG. 6.

At 910, the method may include selecting a subset of logical channels, from the set of logical channels, associated with data units in a buffer of the UE that satisfy a delay condition for transmission. The operations of 910 may be performed in accordance with examples as described herein. In some implementations, aspects of the operations of 910 may be performed by a UE as described with reference to FIG. 6.

At 912, the method may include assigning, via a MAC layer of the UE, the uplink resources allocated by the uplink grant to the selected subset of logical channels. The operations of 912 may be performed in accordance with examples as described herein. In some implementations, aspects of the operations of 912 may be performed by a UE as described with reference to FIG. 6

It should be noted that the method described herein describes a possible implementation, and that the operations and the steps may be rearranged or otherwise modified and that other implementations are possible.

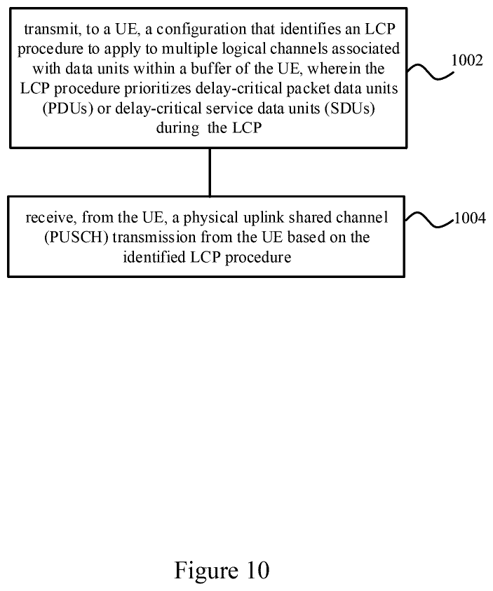

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting to a UE a configuration that identifies an LCP procedure to apply to multiple logical channels associated with data units within a buffer of the UE, wherein the LCP procedure prioritizes delay-critical PDUs or delay-critical SDUs during LCP. The operations of 1002 may be performed in accordance with examples as described herein. In some implementations, aspects of the operations of 1002 may be performed by an NE as described with reference to FIG. 8.

At 1004, the method may include receiving, from the UE, a PUSCH transmission from the UE based on the identified LCP procedure. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

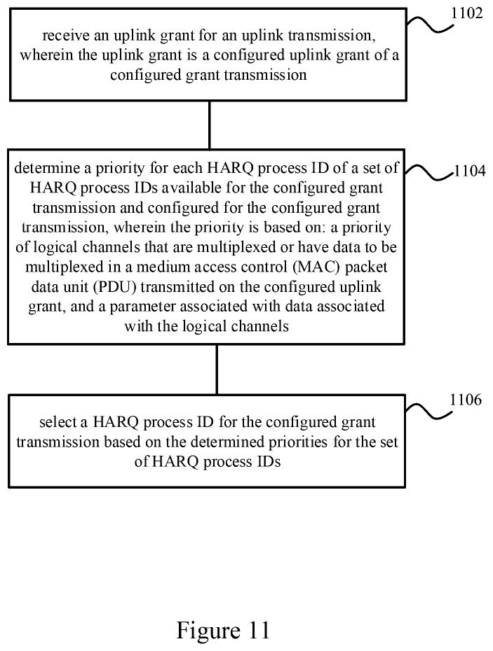

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving an uplink grant for an uplink transmission, wherein the uplink grant is a configured uplink grant of a configured grant transmission. The operations of 1102 may be performed in accordance with examples as described herein. In some implementations, aspects of the operations of 1102 may be performed by a UE as described with reference to FIG. 6.

At 1104, the method may include determining a priority for each HARQ process ID of a set of HARQ process IDs available for the configured grant transmission and configured for the configured grant transmission, wherein the priority is based on: a priority of logical channels that are multiplexed or have data to be multiplexed in a MAC PDU transmitted on the configured uplink grant, and a parameter associated with data associated with the logical channels. The operations of 1104 may be performed in accordance with examples as described herein. In some implementations, aspects of the operations of 1104 may be performed by a UE as described with reference to FIG. 6.

At 1106, the method may include selecting a HARQ process ID for the configured grant transmission based on the determined priorities for the set of HARQ process IDs. The operations of 1106 may be performed in accordance with examples as described herein. In some implementations, aspects of the operations of 1106 may be performed by a UE as described with reference to FIG. 6.

It should be noted that the method described herein describes a possible implementation, and that the operations and the steps may be rearranged or otherwise modified and that other implementations are possible.

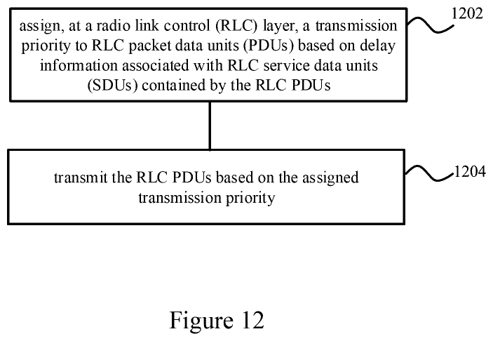

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may include assigning, at an RLC layer, a transmission priority to RLC PDUs based on delay information associated with RLC SDUs contained by the RLC PDUs. The operations of 1202 may be performed in accordance with examples as described herein. In some implementations, aspects of the operations of 1202 may be performed by a UE as described with reference to FIG. 6.

At 1204, the method may include transmitting the RLC PDUs based on the assigned transmission priority. The operations of 1204 may be performed in accordance with examples as described herein. In some implementations, aspects of the operations of 1204 may be performed by a UE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive an uplink grant for an uplink transmission,
wherein the uplink grant is a configured uplink grant of a configured grant transmission;
determine a priority for each hybrid automatic repeat request (HARQ) process ID of a set of HARQ process IDs available for the configured grant transmission and configured for the configured grant transmission,
wherein the priority is based on:
a priority of logical channels that are multiplexed or have data to be multiplexed in a medium access control (MAC) packet data unit (PDU) transmitted on the configured uplink grant; and
a parameter associated with data associated with the logical channels; and
select a HARQ process ID for the configured grant transmission based on the determined priorities for the set of HARQ process IDs.

2. The UE of claim 1, wherein the parameter comprises a latency value for the data associated with the logical channels.

3. The UE of claim 2, wherein the parameter comprises a remaining time that is available for transmission of the data associated with the logical channels.

4. The UE of claim 1, wherein the data associated with the logical channels comprises a radio link control (RLC) service data unit (SDU).

5. The UE of claim 1, wherein the data associated with the logical channels comprises delay-critical service data units (SDUs).

6. The UE of claim 1, wherein the data associated with the logical channels comprises delay-critical packet data units (PDUs).

7. A processor for wireless communication, comprising:
at least one controller coupled with at least one memory and configured to cause the processor to:
receive an uplink grant for an uplink transmission,
wherein the uplink grant is a configured uplink grant of a configured grant transmission;
determine a priority for each hybrid automatic repeat request (HARQ) process ID of a set of HARQ process IDs available for the configured grant transmission and configured for the configured grant transmission,
wherein the priority is based on:
a priority of logical channels that are multiplexed or have data to be multiplexed in a medium access control (MAC) packet data unit (PDU) transmitted on the configured uplink grant; and
a parameter associated with data associated with the logical channels; and
select a HARQ process ID for the configured grant transmission based on the determined priorities for the set of HARQ process IDs.

8. The processor of claim 7, wherein the parameter comprises a latency value for the data associated with the logical channels.

9. The processor of claim 8, wherein the parameter comprises a remaining time that is available for transmission of the data associated with the logical channels.

10. The processor of claim 7, wherein the data associated with the logical channels comprises a radio link control (RLC) service data unit (SDU).

11. The processor of claim 7, wherein the data associated with the logical channels comprises delay-critical service data units (SDUs).

12. The processor of claim 7, wherein the data associated with the logical channels comprises delay-critical packet data units (PDUs).

13. A method performed by a user equipment (UE), the method comprising:
receiving an uplink grant for an uplink transmission,
wherein the uplink grant is a configured uplink grant of a configured grant transmission;
determining a priority for each hybrid automatic repeat request (HARQ) process ID of a set of HARQ process IDs available for the configured grant transmission and configured for the configured grant transmission,
wherein the priority is based on:
a priority of logical channels that are multiplexed or have data to be multiplexed in a medium access control (MAC) packet data unit (PDU) transmitted on the configured uplink grant; and
a parameter associated with data associated with the logical channels; and
selecting a HARQ process ID for the configured grant transmission based on the determined priorities for the set of HARQ process IDs.

14. The method of claim 13, wherein the parameter comprises a latency value for the data associated with the logical channels.

15. The method of claim 14, wherein the parameter comprises a remaining time that is available for transmission of the data associated with the logical channels.

16. The method of claim 13, wherein the data associated with the logical channels comprises a radio link control (RLC) service data unit (SDU).

17. The method of claim 13, wherein the data associated with the logical channels comprises delay-critical service data units (SDUs).

18. The method of claim 13, wherein the data associated with the logical channels comprises delay-critical packet data units (PDUs).

19. A user equipment (UE) for wireless communication, comprising:
at least one memory; and
at least one processor coupled with the at least one memory and configured to cause the UE to:
assign, at a radio link control (RLC) layer, a transmission priority to RLC packet data units (PDUs) based on delay information associated with RLC service data units (SDUs) contained by the RLC PDUs; and
transmit the RLC PDUs based on the assigned transmission priority.

20. The UE of claim 19, wherein the at least one processor is configured to cause the UE to assign a higher transmission priority to a RLC PDU containing a RLC SDU or RLC SDU segment that has not been previously transmitted with respect to a RLC PDU containing a previously transmitted RLC SDU or RLC segment.
